(19) United States
(12) Patent Application Publication
(10) Pub. No.: US 2017/0225954 A1
(43) Pub. Date: Aug. 10, 2017

(54) DIAMOND UNIT CELL AND DIAMOND MASS BY COMBINATORIAL SYNTHESIS

(71) Applicants: Daniel HODES, Bethesda, MD (US); Arnold L. NEWMAN, Bethesda, MD (US)

(72) Inventors: Daniel HODES, Bethesda, MD (US); Arnold L. NEWMAN, Bethesda, MD (US)

(73) Assignee: Unit Cell Diamond LLC, Bethesda, MD (US)

(21) Appl. No.: 15/428,897

(22) Filed: Feb. 9, 2017

Related U.S. Application Data
(63) Continuation-in-part of application No. 14/713,005, filed on May 15, 2015, now abandoned.
Application No. 14/713,005 is a division of application No. 14/120,508, filed on May 28, 2014, now Pat. No. 9,061,917.
Application No. 14/120,508 is a continuation-in-part of application No. 13/204,218, filed on Aug. 5, 2011, now Pat. No. 8,778,295.
(60) Provisional application No. 61/344,510, filed on Aug. 11, 2010.

(51) Int. Cl. B01J 3/06; B01J 19/00

(52) U.S. Cl. CPC C01B 31/06; B01J 19/0046; B01J 2219/00736

(57) ABSTRACT

A product of a chemical reaction, being a five carbon atom molecule having a tetrahedral structure consisting of four apical carbon atoms and a fifth carbon atom located centrally within the tetrahedral structure.

### FIELD OF THE INVENTION

The present invention pertains to the combinatorial synthesis of the diamond unit cell and man-made diamond masses produced therefrom.

### BACKGROUND OF THE INVENTION

Diamond is a valuable material due its properties of hardness (10 on the Mohs hardness scale), heat stability, high room temperature thermal conductivity (about 2000 W/m° K), very low rms vibration at room temperature (0.002 nm), a high index of refraction (2.4), optical transparency from infrared through visible, and UV fluorescence. Because of its high band gap (5.45 eV) it is a superb electrical insulator (10¹⁶ ohm, or more). Boron-doped (blue) diamond has been found to be p-type semiconductor having a high hole mobility and electrical breakdown strength. Such properties may afford diamond utility with respect to substrates for micro-electronic devices, ultraviolet light protective coatings, high energy laser device windows, and even diamond semiconductor devices. Such applications require that diamond be ultra-pure.

Many synthetic methods for diamond are known. These methods produce diamond either from elemental carbon or from elemental carbon obtained from a compound or compounds of carbon, which methods subject elemental carbon to conditions under which the carbon will form the crystalline species known as diamond. Typically, these methods involve high pressure, high temperatures, or high energy discharges. Moreover, post treatments are frequently necessary for purification. Most of these methods do not produce ultra-pure diamond, however.

### SUMMARY OF THE INVENTION

It is an object of the present invention to provide the diamond unit cell.

It is further an object of the present invention to provide the diamond unit cell produced from combinatorial synthesis of a tetrahedranoidal compound and a carbon atom.

Moreover, it is a further object of the present invention to provide diamond masses made from diamond unit cells. These objects and others are provided by a product of a chemical reaction, being a five carbon atom molecule having a tetrahedral structure consisting of four apical carbon atoms and a fifth carbon atom located centrally within the tetrahedral structure. This molecular structure is also referred to herein as the “diamond unit cell”.

### DETAILED DESCRIPTION OF THE PREFERRED EMBODIMENTS

The present invention provides diamond unit cells and diamond masses made therefrom, wherein the drawbacks of CVD diamond-making processes are avoided.

### Term Definitions

Combinatorial Synthesis: as used herein means the reaction of a tetrahedranoidal compound with a carbon atom to produce the diamond unit cell.

In the present specification, the words “tetrahedranoidal” and “tetrahedranoid” are used interchangeably. As used herein, the terms “tetrahedranoidal” and “tetrahedranoid” mean a molecule having a shape resembling a catcher's mitt, which contains a bridge head carbon atom. Thus, as used herein, the terms “tetrahedranoidal” and “tetrahedranoid” refer to the shape of the entire molecule, and not to the type of bonding or bonding angle between adjacent atoms in the molecule. Exemplary species of such compounds are benzvalene, dihydrobenzvalene, tetrahedranone and/or 3,4-diazabenzvalene. The “tetrahedranoidal” and/or “tetrahedranoid” compound is one of the reactants in the combinatorial synthesis.

As used herein, “tetrahedral” is used to describe the geometric shape of the chemical reaction product of the combinatorial synthesis, which is a five carbon molecule having four apical carbon atoms and a fifth carbon atom located centrally within the tetrahedral structure. This molecular product is also referred to herein as the diamond unit cell. This chemical reaction product is not to be confused with the theoretical crystal construct known as the unit cell, which does not refer to the actual, synthesizable molecule disclosed herein, but is, rather, merely a theoretical construct which is useful in identifying crystallographic properties, such as crystal symmetry. In fact, no crystal unit cell as used in chemistry, and, more particularly in crystallography, may be thought of as real molecule given the dangling valences which are a necessary consequence of the structural truncation required to position the unit cell. In short, crystal unit cells are devised for mathematical convenience and are never considered real chemical entities. For example, the “cubic unit cell” of diamond, as such a theoretical construct, contains 4 true diamond unit cells as part of that construct. In contrast, the present invention provides an unprecedented means for synthesizing the true diamond unit cell, a five carbon atom molecule, by itself, by the combinatorial synthesis.

Apical as used herein simply refers to the corner positions in the tetrahedral structure of the chemical reaction product having five carbon atoms with four apical carbon atoms and a fifth carbon atom located centrally with the tetrahedral structure.

No diamond seed: as used herein means that no seed of either diamond or other mineral is used to produce either the diamond unit cell or diamond mass. No diamond seed or other mineral seed is provided to the product diamond mass.

Homogeneous morphology: as used herein means that the product diamond mass is at least a contiguous, non-particulate solid in structure and appearance.

No coloration as a result of formation: means that the present diamond mass does not incur discoloration simply as a consequence of formation by combinatorial synthesis. Conventional synthetic diamonds usually exhibit a yellow or yellow-brown discoloration as a result of nitrogen oxide inclusions in the diamond crystal due to the extreme high pressure/high pressure temperature (HP/HT) conditions used in conventional diamond forming processes in the presence of atmospheric air. The present diamond mass does not suffer from this disadvantage as HP/HT conditions are avoided as is atmospheric air.

No nitrogen getters: means that no compounds or metals are added to the present diamond mass during growth to prevent formation of nitrogen oxide inclusions. In conventional synthetic diamond forming reactions using HP/HT conditions under atmospheric air, nitrogen getters must be added to absorb or react with nitrogen in the air to prevent reaction of nitrogen and oxygen forming nitrogen oxides. Conventionally, aluminum or titanium have been used to remove nitrogen from growing diamond crystal. In contrast, the present diamond mass is free of nitrogen. Thus, no color zonation is present in the diamond mass produced by the combinatorial synthesis of the diamond unit cell.

No color zonation: means that the present diamond mass contains no differential color zones due to impurities in contrast to natural and conventional synthetic diamond.

“Combinatorial Synthesis of Diamond” (Hodes, U.S. Pat. No. 8,778,295, from Ser. No. 13/204,218, filed Aug. 5, 2011, which claims priority to 61/344,510, filed Aug. 11, 2010 herein incorporated by reference) is directed to a vapor phase synthesis of diamond wherein a carbon atom (C) free of meta-stable radical impurities (methyl radical-CH₃., di-radical methylene-CH₂:, tri-radical methyne-.CH:) is obtained from a hydrocarbon source. This carbon atom so obtained is reacted with a species produced by catalytic treatment of acetylene. The combinatorial reaction of these two reactants yields diamond, which precipitates from the vapor phase. While not being bound by theory, it is believed that the species derived by catalytic treatment of acetylene is tetrahedrane, albeit transient and in low concentration. The product of this reaction is the diamond unit cell, that is, a five carbon atom molecule having a tetrahedral structure consisting of four apical carbon atoms and a fifth carbon atom located centrally within the tetrahedral structure. A 2D representation of the 3D structure of the diamond unit cell is shown below.

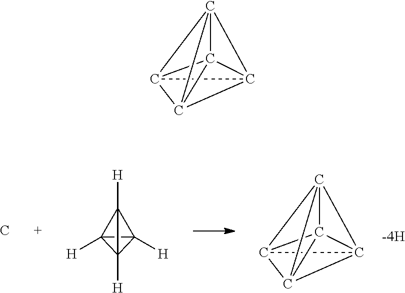

The present disclosure is directed to the diamond unit cell produced by combinatorial synthesis. Formation of diamond by a synthesis of its unit cell as disclosed in this disclosure and in a previous disclosure by Dr. Hodes proceeds by a method altogether different from the typical methods of diamond formation. Synthesis of the diamond unit cell relies upon chemical modification of molecules having structures similar to that of the diamond unit cell. That is, they are tetrahedral or nearly tetrahedral, structurally, and have chemical reactivity that can be exploited to alter their structure to produce the diamond unit cell. Stable, isolable tetrahedranes are known. Their stability is an artifact of the four bulky substituents on the four carbon atoms comprising the molecules. However, it is this very large steric bulk that makes them unsuitable for use as reactants in a diamond unit cell forming reaction.

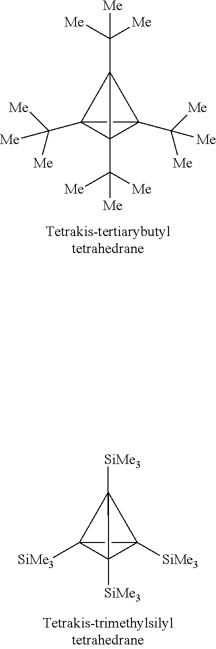

The diamond unit cell forming reaction of this disclosure proceeds by the reaction of a carbon atom free of meta-stable radical impurities, which is derived from a source hydrocarbon, with a second chemical species whose structure is closely related to tetrahedrane—a tetrahedranoidal structure. In fact, for purposes of the present invention, tetrahedrane, itself, is considered to be a tetrahedranoidal structure. These tetrahedranoidal compounds are generally understood, however, as tetrahedranes having the 3,4 C—C bond replaced by an “insert” species.

Examples of four well-known tetrahedranoidal compounds useful in this diamond unit cell forming reaction are shown below (NON-IUPAC naming for simplicity).

Compound I—Benzvalene (C₆H₆) bp=77.558° C. (760 mm Hg) vapor pressure 106.123 mmHg at 25° C. The “inserted” species is —CH═CH— (ethylene).

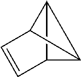

Compound II—2,3,4-methynyl-cyclobutanone (“Tetrahedranone”, “Carbonyl tetrahedrane”) (C₆H₄O) bp=−37° C. (some decomposition). The inserted species is CO (carbonyl, carbon monoxide).

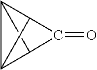

Compound III—3,4,5-methynyl-dihydro-1,2-pyrazole (3,4-Diazabenzvalene) (C₄H₄N₂); decomposes at about −60 degrees C. The inserted species is —N═N— (dinitrogen), i.e., a diazo group.

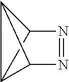

Compound IV—Dihydro-benzvalene (C₆H₈) bp=78.5° C. (760 mm Hg) vapor pressure 102 mm Hg at 25° C. [(thermal decomposition ˜300° C.)]

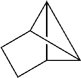

The four tetrahedranoidal compounds detailed above have sufficient thermodynamic stability to be used as a reactant in the diamond unit cell forming reactions detailed below providing that appropriate manipulative care is used with respect to their individual peculiarities. However, one should not consider these compounds to be thermodynamically stable, overall. In fact, it is the very instability of these compounds that is exploited by the diamond unit cell syntheses of this disclosure. Diazabenzvalene and 2,3,4-methynylcyclobutanone (“tetrahedranone”) both decompose by ejection of a leaving group (N₂ and CO, respectively) to a C₄H₄ transient species, which may be seen spectroscopically as the dimer C₈H₈ indicative of the initial formation of cyclobutadiene. The presence of dicyclobutadiene in the environment of the diamond unit cell forming reaction is highly undesirable because it is also highly reactive and will produce condensation products, which will inevitably contaminate the diamond mass under formation. Thus, the use of these compounds in diamond unit cell syntheses requires rigorous manipulative technique. By contrast, benzvalene (C₆H₆) does not decompose per se; rather, it rearranges to benzene (C₆H₆) under the conditions of the diamond unit cell syntheses disclosed herein. Despite benzvalene's more advantageous properties, as compared to diazabenzvalene or “tetrahedranone” in the diamond unit cell syntheses of this disclosure, one skilled in the art will recognize that relaxation of rigorous manipulative care can result in an impurity, which is highly undesirable and must be prevented from contacting the diamond mass under formation because benzene is notorious for imparting graphitic impurities into products of processes such as chemical vapor deposition. One of normal skill in the art will recognize that the vapor pressure/boiling point, thermal stability, and lack of rearrangement compounds for dihydro-benzvalene suggest it to be advantageous as a tetrahedranoidal synthon for the combinatorial synthesis of the diamond unit cell disclosed herein.

Compounds I and H are reasonably stable in the presence of oxygen, and these compounds have good stability at ambient temperatures. Compound III decomposes at about −60° C. and is unstable in the presence of oxygen. Compounds I and H decompose rapidly and even violently if they contact sharp surfaces. Compounds I and II are sensitive to rapid heating, and the rate of heating must not exceed 5° C. per minute. Compounds I, II, and III are stored and used in inert atmospheres such as helium or argon, which gases should be of research purity having no more than 10 ppm impurities which impurities are identifiable by GC/MS. Reactant manipulation within an anaerobic environment eliminates the formation of O₂-induced radicals leading to impurities in the reactants, which deleteriously effect the product of the diamond unit cell forming reactions in which they are used. Thus, a similar level of purity of inert gases used in the diamond unit cell forming reactions is maintained. In one embodiment, purity is maintained using Schlenck (double manifold) techniques.

All four compounds react with a “clean” carbon atom to create the diamond unit cell along with concomitant ejection of 4 hydrogen atoms and the “inserted” species (HC≡CH, CO, N₂, C₂H₄ for compounds I, II, III, and IV, respectively).

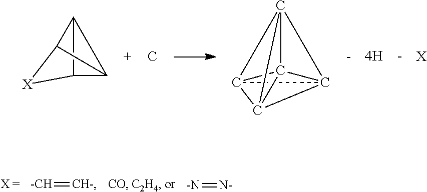

Diamond unit cells assemble to form a diamond mass. Thus, the diamond mass is formed by the assembly of a plurality of diamond unit cells, i.e., diamond molecules.

Spectral examination of diamond formed by this method using Raman or Infrared reflectance reveals only peaks associated with diamond. For example, C—H stretching bands at 2800-3000 cm⁻¹ typically observed for CVD diamond using methane gas are not observed. Graphitic impurities (sp² carbon) at 1580 cm⁻¹, which are frequently observed in CVD diamond, are not observed. The sharp peak at 1328-1332 cm⁻¹, characteristic of diamond, is observed.

Sources of atomic carbon may include saturated hydrocarbons such as methane, ethane, and cycloalkanes. In one embodiment, the carbon atom source is cubane.

Cubane (C₈H₈) MW=104.1491 mp=131° C. bp=133° C. vapor pressure=1.1 mm at 25° C.

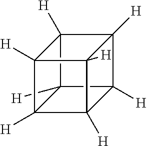

Cubane, which has a strain energy of 166 kcal/mol, decomposes cleanly in a high energy discharge environment to yield carbon and hydrogen free of meta-stable radical impurities. In one embodiment, cubane is decomposed to hydrogen and carbon free of meta-stable radical impurities using a microwave discharge (1 kW at 12 GHz being adequate).

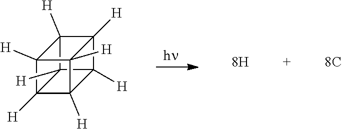

Other sources such as methane, ethane, and other lower alkanes and also cycloalkanes which decompose to atomic carbon can be used as such sources in vapor phase diamond unit cell

In one embodiment, the diamond unit cell forming reaction is conducted in the vapor phase. In another embodiment, the diamond unit cell forming reaction is conducted in the solid state. In one embodiment of the solid state diamond unit cell forming reaction, a high degree of stoichiometric precision is employed to ensure a high degree of purity for the diamond product. An excess of cubane (the carbon atom source) introduces graphitic and amorphous carbon impurities into the diamond product. Excess tetrahedranoid can introduce C—H, graphitic, and even heteroatom impurities into the diamond product. The tetrahedranoid-to-cubane stoichiometry is 8:1. In one embodiment, the tetrahedranoid-to-cubane stoichiometry is precisely 8:1.

Thus, in one embodiment, stock solutions of cubane and tetrahedranoid compounds to be used are prepared and analyzed by liquid chromatography for concentration and for the presence of impurities. The impurities differ depending on the tetrahedranoid used. For example, the principal impurity in benzvalene is benzene, which is notorious for imparting graphitic impurities into diamond. “Tetrahedranone” decomposes emitting carbon monoxide and rearranging to cyclobutadiene, seen spectroscopically as the dimer, dicyclobutadiene. “Tetrahedranone” can be separated from this impurity by slow and careful sublimation onto a −78° C. cold finger and recovered under inert atmosphere. The practitioner will understand that manipulative care must be exercised for these tetrahedranoidal compounds based upon their previously disclosed properties: benzvalene and “tetrahedranone” must be heated gently as previously described, and diazabenzvalene must be used below about −60° C., entirely under anaerobic conditions. Commercially available liquid chromatography instruments are available for the quantitative and qualitative analyses required for stock solutions of reactants. Further, computer databases are available with such instruments for qualitative analyses of impurities (if any), and such instruments can provide the four place precision (and even higher) for quantitative analyses in these reactions. This allows preferred levels of precision for the diamond unit cell forming reactions to be obtained.

The purity of the diamond produced by the solid phase diamond unit cell forming reaction is an artifact of the purity of the reactants used. Thus, the process begins with the use of purified reactants. More specifically, the carbon atom source and the tetrahedronoidal compounds are purified. In one embodiment, the solutions of the individual reactants are prepared for analysis and standardization by liquid chromatography or by spectroscopic analysis. If the analysis verifies the requisite purity for the reaction, standardized stock solutions of precisely determined concentrations are prepared.

In one embodiment, the tetrahedranoidal compound (benzvalene, in this example) is adequately purified by placing it in a Schlenck (double manifold) vessel having a threaded wide mouth port, a septum port, and valved gas/vacuum arms operatively connected to the double manifold apparatus with a flow of inert gas (argon). The vessel is chilled to between −20° C. and −45° C. and then evacuated to remove benzene (if any). Inert sweep gas is admitted, and an aliquot of the sweep is sampled by GC/MS to determine the presence of impurities. When no impurities are detected, a solvent, such as dichloromethane (in one embodiment at least research grade) distilled under argon from CaH₂ is added to prepare a stock solution, an aliquot of which is analyzed by liquid chromatography for standardizing the concentration of the solution. Stock solutions of “tetrahedranone” and of cubane are prepared similarly. Cubane may also be purified by sublimation in vacuum. Repeated sublimations of cubane are known to provide a product of very high purity with very small mass loss, overall.

In another embodiment, Schlenck (multiple manifolds) line solution transfer techniques are used to deliver reactants to their respective reaction receivers. The solutions are chilled and then freed of solvent under vacuum. Confirmation of complete solvent removal is done by GC/MS analysis of inert sweep gas. Alternatively, the tetrahedronoidal compounds I and II are purified using commercially available quantitative liquid chromatography apparatus.

Solutions of the carbon atom source (e.g. cubane) and the tetrahedranoidal compound are then combined and transferred to a reaction vessel. This solution is freed of solvent under reduced pressure and temperature. More specifically, the solutions are chilled and solvent is evaporated under reduced pressure slowly to prevent bumping. Once the solvent appears to be completely removed, a flow of inert gas is passed over the remaining solid residue and sampled by GC/MS to verify that no residual solvent remains. If any solvent remains, the process is repeated (pumping and sampling) until no residual solvent remains. Thereupon, the vessel is filled with inert gas, sealed, and transferred to a dry box for transfer of the reaction vessel to a high energy discharge cell. In one embodiment the high energy discharge cell is a microwave, an electrostatic discharge device, or other high-energy discharge known in the bond cleavage art. The cell is sealed, removed from the dry box, connected to the double manifold apparatus, fitted with refrigerant lines to circulate refrigerant through the cold plate, and the exit port is connected to a GC/MS instrument as well as any additional ports as needed. Upon adequate chilling of the solid reaction mixture within the reaction vessel placed upon the cold plate, the discharge is energized to initiate the diamond unit cell forming reaction while the effluent is monitored by GC/MS. In one embodiment, this process is conducted under vacuum. In another embodiment, this process is conducted in an inert gas. When no more ejection products are observed spectroscopically, energy to the discharge cell is discontinued and the product is removed from the reaction vessel and transferred to a spectrometer for product analysis.

In one embodiment, the reaction vessel containing the solid reaction is placed on a cold plate and chilled to between −20° C. and −45° C. within a microwave discharge cell under an inert atmosphere. At higher temperatures the tetrahedranoidal compound(s) have sufficient vapor pressure to alter the precision of the stoichiometry.

In another embodiment, the cell is energized to effect the reaction, which is complete in about three to five seconds for a 1 mmol scale reaction. In one embodiment, the reaction is conducted under reduced pressure. In another embodiment, the reaction is monitored by GC/MS at the effluent port to determine when no more ejection products are detected. In an embodiment wherein diazabenzvalene is the tetrahedranoidal reactant, the cold plate is kept at about −60° C. to −78° C., or even lower.

Having described the present invention, reference is made below to certain examples that are provided solely for purposes of illustration and are not intended to be limitative.

### Example

A solid state diamond unit cell forming reaction was performed as follows.

A teflon lined glass receiver cylinder having a 2 cm diameter and 5 cm wall height was placed in a Schlenck vessel having a threaded wide mouth, gas/vacuum valve port, and septum port to which was attached an electronically controlled syringe pump. The vessel was sealed and evacuated followed by admission of argon and chilling in a dry ice/chlorobenzene bath (−45° C.). Using the syringe pump a first precisely standardized solution of 1 mmol of benzvalene in dry dichloromethane was delivered into the contained cylinder. A second precisely standardized solution of 0.125 mmol of cubane in dry dichloromethane was delivered to the contained cylinder to afford an 8:1 (molar) mixture of benzvalene and cubane in dichloromethane. The syringe tube (needle) was removed, and argon flow was stopped. Vacuum was applied slowly to minimize bumping, and the solvent was removed under complete vacuum (about 10 minutes). Argon was readmitted when visual observation of the cylinder indicated that it contained a dry (solvent free) solid. A portion of the argon flow was sampled by GC/MS to confirm complete removal of dichloromethane and absence of benzene. The cold bath was removed. The vessel was transferred to the load-lock of a glove box having an argon atmosphere, and the cylinder bearing the homogeneous mixture of solid cubane and benzvalene was removed from the Schlenck vessel and transferred to a microwave discharge cell. The cell was sealed, removed from the glove box, fitted with refrigerant lines to the cold plate on which the contained reaction cylinder was mounted, attached to the Schlenck line, attached to a GC/MS instrument at the cell effluent port, and refrigerant was circulated through the cold plate to maintain the reactant mixture at −45° C. Argon flow through the cell was initiated with commencement of GC/MS effluent monitoring. The cell was then energized to initiate the diamond forming reaction. When GC/MS effluent monitoring indicated the effluent to be free of hydrogen or acetylene (about 5 seconds), energy to the discharge cell was ceased, refrigerant circulation was ceased, and the cell was opened to recover the reaction vessel. The glassy disc within the cell was brought to an FTIR reflectance instrument, which confirmed diamond (1328-1332 cm⁻¹ No graphite, amorphous carbon, or C—H peaks were observed. The weight of the disk was 59.12 mg (98.4% of theoretical).

### Example 2

A vapor phase diamond unit cell forming reaction was performed as follows.

A teflon lined glass receiver cylinder having a 2 cm diameter and 5 cm wall height was placed in a Schlenck vessel having a threaded wide mouth, gas/vacuum valve port, and septum port to which was attached an electronically controlled syringe pump. The vessel was sealed and evacuated followed by admission of argon and chilling in a dry ice/chlorobenzene bath (−45° C.). Using the syringe pump a solution of 2 mmol of benzvalene in dichloromethane was delivered into the container cylinder. A second teflon lined glass receiver cylinder having a 2 cm diameter and 5 cm wall height was placed in a second Schlenck vessel having a threaded wide mouth, gas/vacuum valve port, and septum port to which was attached an electronically controlled syringe pump. The vessel was sealed and evacuated followed by admission of argon and chilling in a dry ice-chlorobenzene bath (−45° C.). Using the syringe pump a solution of 0.125 mmol of cubane in dichloromethane was delivered into the contained cylinder. The syringe lines (needles) were removed from both vessels. The flow of argon was ceased to both vessels. Vacuum was applied slowly to both vessels to minimize bumping, and the solvent was removed under complete vacuum (about 10 minutes). Argon was readmitted to both vessels when visual observation of the cylinders indicated that both contain a dry (solvent free) solid. A portion of the argon flow was sampled by GC/MS to confirm complete removal of dichloromethane and absence of benzene. The cold bath was removed. The vessels were transferred to the load-lock of a glove box having an argon atmosphere, and the cylinder bearing cubane was transferred to the evaporator contained within the microwave discharge cell and sealed. The benzvalene-containing cylinder was transferred to an evaporation cell having gas/vacuum valved fittings, which were closed. Both cells were transferred to a CVD reactor, attached to gas/vacuum fittings, and configured for the diamond forming reaction by CVD.

A silicon foil disk deposition target was heated to 85° C. Then, using pre-programmed values, gas flow, heating of both evaporators, and application of energy to the microwave discharge were initiated with monitoring of the effluent by GC/MS. When no more reaction by products were detected by GC/MS, the reaction is terminated, and the substrate is allowed to come to ambient temperature, whereupon it was removed and weighed. Yield was 59.77 mg (99.5% of theoretical). FTIR reflectance confirmed the glassy film deposited upon the substrate to be diamond showing no graphite, amorphous carbon, or C—H peaks.

### Additional Considerations for Vapor Phase Reactions

For the vapor phase reaction, precise stoichiometry is not required. Rather, an excess of tetrahedranoidal compound is favored. That is, a tetrahedranoidal compound-to-cubane of ratio equal to or greater than 8:1 is used. Preferably, the ratio is 16:1 (or greater) to ensure that all atomic carbon is reacted in the vapor phase to precipitate the diamond unit cell onto the substrate. The tetrahedranoidal compounds that may be used for this are benzvalene and 2,3,4-methynyl-cyclobutanone (“tetrahedranone”). Benzvalene is advantageous over tetrahedranone because it is more stable and more readily and economically obtained. The impurity due to autogenous rearrangement for benzvalene is benzene while the impurity obtained by autogenous decomposition of tetrahedranone is dicyclobutadiene, which is far more difficult to maintain in the vapor phase than benzene. Benzene can introduce graphitic impurities into diamond obtained by its deposition during the diamond unit cell forming reaction if allowed to come into contact with the deposition substrate. Benzene, if it is present, can be prevented from contaminating the diamond deposited upon the substrate by the diamond unit cell forming reaction (vapor phase) by two means.

First, one need only heat the substrate holder (hence the substrate) to about 80-85° C. transferring sufficient heat to the vapor phase reaction zone vicinal the deposition substrate to “drive off” any benzene that may be present. Alternatively, a second flow of heated carrier gas may be provided along the surface of the deposition substrate to maintain a “thermal barrier zone” against benzene if it is present, Such measures against benzene contamination may not necessarily be needed if benzvalene is properly handled, particularly during its vaporization. Thus, if rapid heating of benzvalene to its vaporization temperature is avoided, benzene formation can be avoided.

### Additional Considerations for Solid State Reactions

The diamond unit cell forming reaction can be conducted in the solid state using a homogeneous mixture of cubane and any of the above-cited tetrahedranoidal compounds. This homogeneous blend is a molar ratio of 8:1, tetrahedranoid-to-cubane. A cubane molecule decomposes to provide eight carbon atoms and eight hydrogen atoms. The skilled practitioner will recognize that a high degree of stoichiometric precision is required when preparing the homogeneous blend of cubane and tetrahedranoid if a diamond product of high purity is to be obtained by the diamond unit cell forming reaction. An excess of cubane (the carbon atom source) introduces graphitic and amorphous carbon impurities into the diamond product. Excess tetrahedranoid can introduce graphitic, carbenoid, and even heteroatom impurities into the diamond product.

Gravimetric methods are unlikely to achieve this level of precision and are difficult to perform with contact-sensitive materials such as benzvalene and 2,3,4-methynylcyclobutanone; 3,4-diazabenzvalene is unstable above −60° C.

Forming stock solutions of the individual reactants (cubane and tetrahedranoid) can achieve this precision with the use of liquid chromatographic equipment in tandem with mass spectrometric instrumentation (HPLC-MS). Such equipment is commercially available and can attain five decimal place precision (and even higher for some research specification models). This equipment can readily identify and separate impurities common to tetrahedranoidal molecules. For benzvalene, the impurity that is observed is benzene. For 3,4-diazabenvalene and 2,3,4-methynlcyclobutanone (“tetrahedranone”) the impurity is dicyclobutadiene, which arises from the ejection of dinitrogen or carbon monoxide, respectively, from these tetrahedranoidal compounds. These are four-carbon units that probably form butadiene, which dimerizes to the final impurity, dicyclobutadiene. Thus, it is advantageous to use benzvalene as the tetrahedranoidal reactant for the solid-state diamond unit cell forming reaction. It is the most stable of the three tetrahedranoidal compounds, and it is fairly economical to use being readily prepared by standard organic synthesis methods from inexpensive reagents.

The use of precisely calibrated stock solutions of the individual reactants using HPLC-MS instrumentation also provides a means for maintaining the stoichiometric precision necessary for producing diamond by the solid state diamond unit cell forming reaction. The two solutions are combined and freed of solvent carefully at reduced pressure and at reduced temperature in the reaction vessel in which the diamond unit cell reaction occurs. The solid blend is held at low temperature in an inert atmosphere because the vapor pressures of the individual reactants are sufficient at ambient temperature (benzvalene: 106.12 mm Hg; cubane: 1.1 mm Hg) to alter the stoichiometric precision of the homogeneous blend by evaporative loss. The combination of double manifold line manipulations and HPLC-MS instrumentation simplifies the task of preparing a stoichiometrically precise blend of purified reactants as well as maintaining their purity and stoichiometry.

The diamond masses produced by the present invention have no detectable impurities, including amorphous carbon, non-diamond allotropes of carbon, hydrocarbenoids, heteroatoms and heteroatom-bearing materials. For example, the diamond masses of the present invention are spectroscopically-free of graphitic impurities, and free of discoloration from nitrogen oxide inclusions or free of discoloration by inclusions of species including oxides of nitrogen. The present diamond masses also contain no nitrogen getter-contaminants.

Further, the present diamond masses contain neither color nor crystal zonation, and exhibit a homogeneous crystal morphology.

Hydrocarbenoids are hydrocarbon-carbene-type reactive intermediates. Heteroatom means atoms other than carbon.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments.

What is claimed:

1. A product of a chemical reaction, being a five carbon atom molecule having a tetrahedral structure consisting of four apical carbon atoms and a fifth carbon atom located centrally within the tetrahedral structure.

2. The chemical reaction product of claim 1, wherein said five carbon atom molecule is generated in situ during a combinatorial synthesis reaction.

3. The chemical reaction product of claim 1, wherein said fifth carbon atom which is centrally located within said tetrahedral structure is obtained from dissociation of a hydrocarbon by a high energy discharge and is inserted into a tetrahedranoidal compound during said combinatorial synthesis.

4. The chemical reaction product of claim 3, wherein said hydrocarbon comprises methane, ethane and/or cycloalkanes.

5. The chemical reaction of claim 3, wherein said hydrocarbon is cubane.

6. The chemical reaction product of claim 3, wherein said tetrahedranoidal compound structurally resembles a catchers mitt, and has a bridge head carbon atom.

7. The chemical reaction product of claim 6, wherein said tetrahedranoidal is benzvalene.

8. The chemical reaction product of claim 6, wherein said tetrahedranoidal compound is dihydrobenzvalene.

9. The chemical reaction product of claim 6, wherein said tetrahedranoidal compound is tetrahedranone.

10. The chemical reaction product of claim 6, wherein said tetrahedranoidal compound is 3,4-diazabenzvalene.

11. The chemical reaction product of claim 6, wherein the tetrahedranoidal compound is reacted with a carbon atom obtained from high energy discharge dissociation of cubane.

12. The chemical reaction product of claim 11, which is performed in vapor phase, wherein a carbon atom obtained from the high energy dissociation of cubane reacts with the tetrahedranoidal molecule in a stoichiometric ratio of tetrahedranoidal compound to cubane molecule of at least 8:1.

13. The chemical reaction product of claim 11, which is performed in a solid state, wherein a carbon atom obtained from the high energy dissociation of cubane reacts with the tetrahedranoidal compound in a stoichiometric ratio of tetrahedranoidal compound to cubane of 8:1 as a homogeneous blend of both compounds.
